(19) United States
(12) Patent Application Publication
(10) Pub. No.: US 2011/0293882 A1
(43) Pub. Date: Dec. 1, 2011

(54) CORDIERITE COMPOSITIONS FOR IMPROVED EXTRUSION PROCESS QUALITY

(76) Inventors: Christopher Lane Kerr, Tioga, PA (US); Pascale Oram, Corning, NY (US)

(21) Appl. No.: 12/788,647

(22) Filed: May 27, 2010

(51) Int. Cl. B32B 3/12; C04B 33/00; C04B 35/195

(52) U.S. Cl. 428/116; 264/630; 501/141

(57) ABSTRACT

A green ceramic composition and a green ceramic body. The green composition and the body formed therefrom have sufficiently high wet strength to prevent formation of defects due to differential flow. The composition does not include calcined clays and comprises hydrated clays, cordierite precursors such as alumina, talc, and silica, and at least one binder. The binder can be present at a level that ranges from 3 wt % up to 10 wt %. A method of making a cordierite green body is also described.

### BACKGROUND

The disclosure relates to green ceramic compositions for cordierite. In particular, the disclosure relates to green bodies formed from such compositions. Even more particularly, the disclosure relates to green cordierite compositions that are used to produce ceramic honeycomb structures.

Cordierite (2MgO.2Al₂O₃.5SiO₂) ceramic bodies having a honeycomb web-like structure are widely used for applications in internal combustion exhaust systems. The web structure comprises numerous individual cells separated by cell walls. Such structures are typically formed by extruding a green composition or batch that includes cordierite precursors such as talc, alumina, silica, and clay, plus an organic binder.

Due to size and filtering requirements, the design of such honeycomb structures call for increased cell density and decreasing cell wall thicknesses. Cell densities in ceramic particulate filters are frequently greater than 400 cells per square inch with cell wall thicknesses of less than 0.005 inch. Extruded green bodies having such dimensions are prone to localized distortion of the cell geometry and defects, such as fast flow webs or swollen webs, due to differential flow of the green batch during extrusion. Depending on the severity of the differential flow, defects known as fast flow webs are formed either parallel or perpendicular to the flow direction.

### SUMMARY

A green ceramic composition and a green ceramic body are provided. The green composition and the body formed therefrom have sufficiently high wet strength to prevent formation of defects due to differential flow. The composition does not include calcined clays and comprises hydrated clays, cordierite precursors such as alumina, talc, and silica, and at least one binder. The binder can be present at a level that ranges from 3 wt % up to 10 wt %.

Accordingly, one aspect of the disclosure is to provide a ceramic green body. The ceramic green body comprises cordierite precursor materials and at least one binder. The cordierite precursor materials comprise talc, at least one hydrated clay, alumina, and silica and are free of calcined clay.

A second aspect of the disclosure is to provide a green ceramic composition comprising cordierite precursor materials and at least one binder. The cordierite precursor materials comprise at least one hydrated clay and are free of calcined clays.

A third aspect of the disclosure is to provide a method of making a green ceramic body. The method comprises the steps of providing a green ceramic batch material comprising cordierite precursor materials and at least one binder, and forming the green ceramic batch material into a green ceramic body. The cordierite precursor materials comprise at least one hydrated clay, talc, alumina, and silica and are free of calcined clay. The binder comprises from 3% to 10% of the batch material by weight.

These and other aspects, advantages, and salient features will become apparent from the following detailed description, the accompanying drawings, and the appended claims.

### BRIEF DESCRIPTION OF THE DRAWINGS

FIG. 1 includes photographs of ribbons extruded at different rates for: a) Reference 1 material with 2.9 wt % binder added; b) Reference 2 material with 5 wt % binder added; and c) Reference 1 material with 5 wt % binder added;

FIG. 2 includes photographs of ribbons extruded at different rates for: a) Sample 1 material with 2.9 wt % binder added; b) Sample 2 material with 2.9 wt % binder added; c) Sample 3 material with 2.9 wt % binder added; and d) Sample 4 material with 2.9 wt % binder added;

FIG. 3 includes photographs of ribbons extruded at different rates for: a) Sample 1 material with 5 wt % binder added; b) Sample 2 material with 5 wt % binder added; c) Sample 3 material with 5 wt % binder added; and d) Sample 4 material with 5 wt % binder added;

FIG. 4 includes photographs of extruded web structures obtained for: a) the Reference 1 material containing 2.9 wt % binder b) the Reference 1 material containing 5 wt % binder; and c) the Reference 2 composition containing 5 wt % binder;

FIG. 5 includes photographs of extruded web structures obtained for: a) the Sample 1 material containing 5 wt % binder; and b) the Sample 2 material containing 5 wt % binder;

FIG. 6 includes: a) an optical micrograph; and b) a scanning electron microscope image of fast flow webs in a ceramic green body; and

FIG. 7 is a plot of wall drag pressure as a function of entry velocity in an extruder barrel.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements and/or combinations thereof, it is understood that the group may consist of any number of those elements recited, either individually or in combination with each other. Unless otherwise specified, a range of values, when recited, includes both the upper and lower limits of the range as well as any and all ranges therebetween.

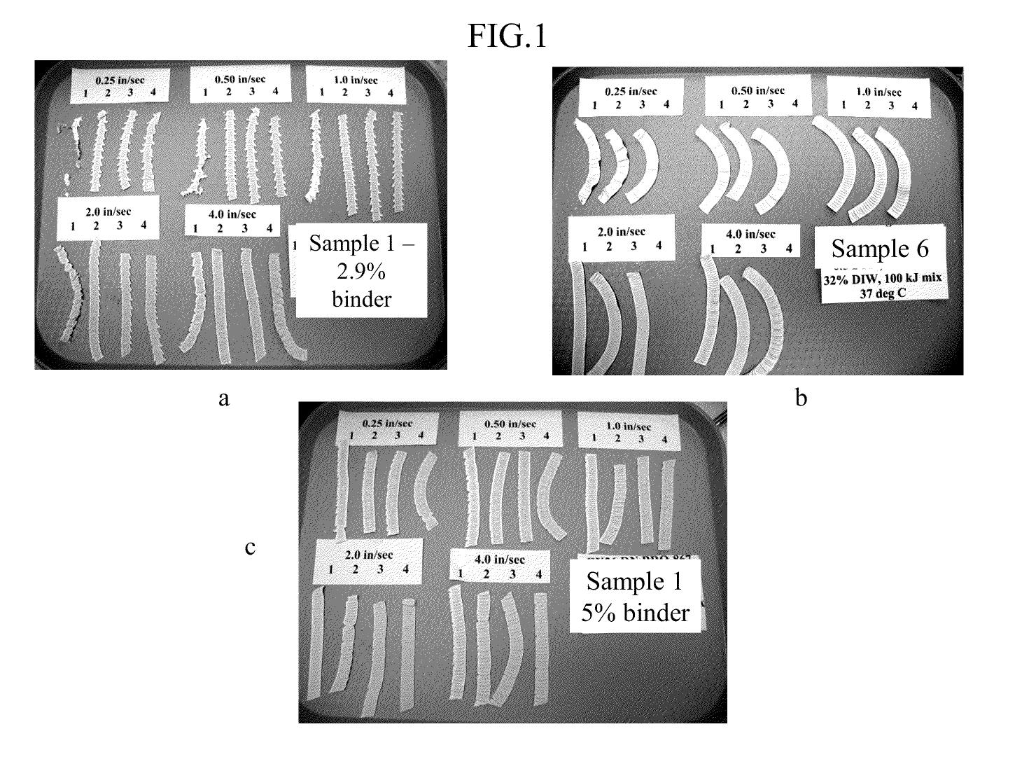

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

As used herein, the terms “green body,” “green ceramic body,” or “ceramic green body” refer to an unsintered body, part, or ware before firing, unless otherwise specified. The terms “green composition” and “green batch material” refer to the mixture of materials that are used to form the ceramic green body, unless otherwise specified. The green body and green batch material contain a vehicle, such as water, and typically comprises at least one precursor of a ceramic material. In addition, the green body and green batch material may also include other materials such as binders, pore formers, stabilizers, plasticizers, deflocculants, lubricants, and the like. As used herein, “firing,” unless otherwise specified, refers to thermal processing at an elevated temperature to form a ceramic material or a ceramic body.

As used herein, the term “calcined clay” refers to clays that have been dehydrated (i.e., water has been removed) by heating at high temperatures. The term “hydrated clays” refers to clays that contain water and have not been calcined.

A green ceramic composition and a ceramic green body are provided. The composition and body rely upon the presence of a minimum level of at least one organic binder and the absence of calcined clay. The green composition and body instead use only hydrated clay and amounts of other alumina and silica raw materials that are necessary to ensure that the final cordierite stoichiometry is achieved after firing the ceramic green body. The green composition and ceramic green body each comprise cordierite precursor materials, at least one binder, and is free of calcined clay. The green composition and ceramic green body can also include other components such as pore formers (e.g., graphite or starches), lubricants, or the like that are known in the art.

Calcined clay typically has an agglomerated structure. The agglomerated structure leads to an increase of the batch surface area as the agglomerated particles break down when the batch is mixed inside an extruder, such as a twin screw extruder. Compared to hydrated clay, the breakdown of calcined clays exposes new particle surfaces that exhibit slightly more hydrophobic behavior. Meanwhile, the chemical structure of the organic binder evolves towards a smaller chain length component. This evolution results from either degradation of the binder structure or the dissolution of the binder in the batch. The binder thus becomes more difficult to access, due to the increasing presence of new bonding sites as the clay breaks down. Undesirable effects resulting from changes in flow properties can be reduced or eliminated in the batch by excluding calcined clay from the batch and increasing the level of binder in the batch.

Cordierite has the formula 2MgO.2Al₂O₃.5SiO₂. As described herein, cordierite precursor materials comprise talc, at least one hydrated clay, alumina, and silica, and are combined together to form a batch material having the green composition, from which the ceramic green body is formed. The cordierite precursor materials are free of calcined clays (e.g., Al₂(Si₂O₅))—i.e., calcined clays are not actively added to the precursor materials or green batch material. Hydrated clays used as cordierite precursors are typically based on the kaolinite structure (Al₂(Si₂O₅)(OH)₄) and include, but are not limited to, kaolinite (Al₂(Si₂O₅)(OH)₄), halloysite (Al₂(Si₂O₅)(OH)₄.H₂O), pryophylilite (Al₂(Si₂O₅)(OH)₂), combinations or mixtures thereof, and the like. Talc is a hydrous magnesium silicate with a layer structure and has the general formula Mg₃(SiO₂)₂(OH)₂. Talc serves as the source of magnesia (MgO) in cordierite. Alumina (Al₂O₃) is added to the batch material to obtain stoichiometric cordierite, and is added in either pure form or in the form of aluminum precursors such as boehmite or aluminum trihydrate. Silica is usually present in its pure chemical state, such as α-quartz or fused silica.

The green composition of the ceramic green body, in some embodiments, comprises: from about 12 to about 16 wt % MgO; from about 33 to about 38 wt % Al₂O₃; from about 49 to about 54 wt % SiO₂; and from about 3 wt % up to about 10 wt % of at least one binder. In one embodiment, the ceramic composition and green body each comprises: from about 12.5 to about 15.5 wt % MgO; from about 33.5 to about 37.5 wt % Al₂O₃; and from about 49.5 to about 53.5 wt % SiO₂. Cordierite-forming and cordierite bodies also typically include impurities such as CaO, K₂O.Na₂O, Fe₂O₃, and the like.

Each of the green ceramic composition and the green body comprises from 3% up to 10 percent by weight of at least one binder. Binders are used to form a flowable dispersion that has a relatively high loading of such ceramic material. Such binders must be chemically compatible with the ceramic batch material and should provide sufficient strength to allow handling of the ceramic green body. Additionally, the binder should be removable from the shaped ceramic green body by heating or “burning out” without incurring distortion or breakage of the ceramic body.

The at least one binder is water-based—i.e., the binder is capable of hydrogen bonding with polar solvents such as water. Such binders include, but are not limited to, methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof. Methylcellulose and/or methylcellulose derivatives—particularly methylcellulose, hydroxypropyl methylcellulose, or combinations thereof—are especially suited as organic binders. Such cellulose binders are commercially available under the brand names METHOCEL® A4M, F4M, F240, and K75M cellulose products from Dow Chemical Co. Methocel A4M cellulose is a methylcellulose. METHOCEL® F4M, F240, and K75M cellulose products are hydroxypropyl methylcellulose.

The at least one binder typically forms a part of a binder system that is added to the ceramic batch. The binder system includes the binder, a solvent for the binder, a surfactant, and a “non-solvent” component that does not act as a solvent with respect to at least the binder and other solvent components. The non-solvent component is a low molecular weight oil that has a lower viscosity than the binder. The low molecular weight oil replaces a portion of the solvent and does not contribute to plasticity, but provides the fluidity necessary for shaping the ceramic batch material while still allowing the batch to remain stiff. Non-limiting examples of non-solvent low molecular weight oils include polyolefin oils, light mineral oils, alpha olefins, and the like. Solvents that are included in the binder system are either water or water miscible. Such solvents provide hydration of the binder and inorganic cordierite precursors. Surfactants for use in the binder system include, for example, C₈-C₂₂ fatty acids and/or their derivatives; C₈-C₂₂ fatty esters; C₈-C₂₂ fatty alcohols; stearic, lauric, linoleic, and palmitoleic acids; and stearic acid in combination with ammonium lauryl sulfate, with stearic, lauric, and oleic acids being particularly preferred.

In one particular embodiment, the binder system comprises: a cellulose ether binder selected from the group consisting of methylcellulose, methylcellulose derivatives, and combinations thereof; a non-solvent light oil comprising polyalpha olefin; a surfactant selected from the group consisting of stearic acid, ammonium lauryl sulfate, lauric acid, oleic acid, palmitic acid and combinations thereof; and water as the solvent.

In some embodiments, the ceramic green body is shaped or formed into a honeycomb structure using those forming means known in the art such as, molding, pressing, casting, extrusion, combinations thereof, and the like. When fired to form a ceramic body, such honeycomb structures can be used as particulate filters in internal combustion systems. The honeycomb structure can include a web structure having a plurality of cells separated by cell walls.

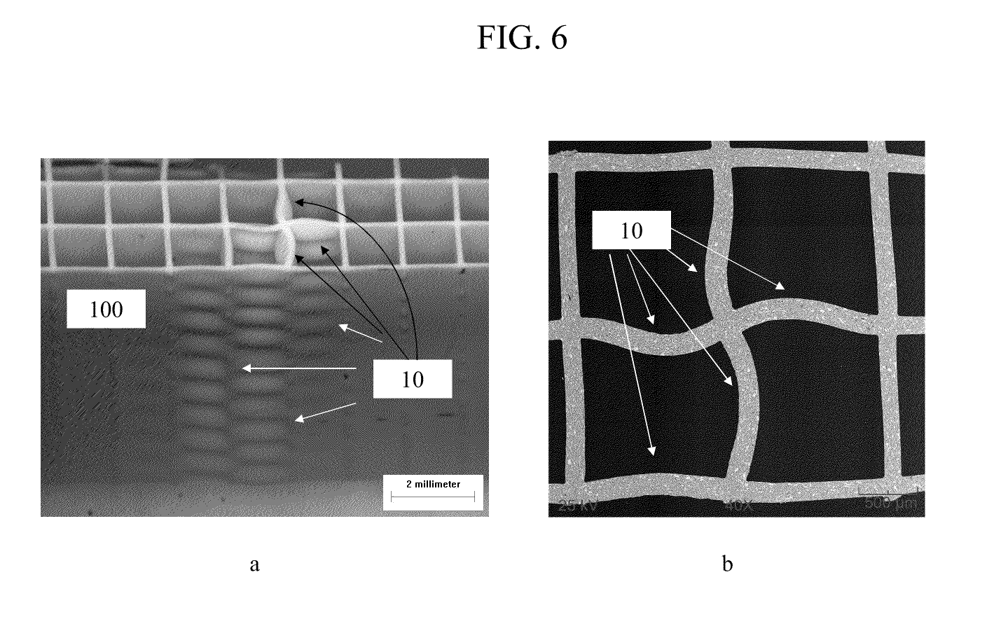

The web structure, in some embodiments, comprises a plurality of cell walls, wherein each of the cell walls has a thickness of less than 0.005 inch. Such thin-walled honeycomb structures are susceptible to distortion, such as swelling or collapse of cell walls or webs, resulting from poor wet strength of the green ceramic batch material, temperature gradients in the extrusion dies or green batch materials, differential shear or flow of the green batch materials through extrusion dies and extrusion barrels, and interactions between the die and/or extrusion barrel and the green batch material. Optical and scanning electron microscope (SEM) images of fast flow webs 10 in an extruded ceramic green body are shown in FIGS. 6a and 6b, respectively. As seen in FIG. 6a, the fast flow webs can propagate down the length of the green body 100.

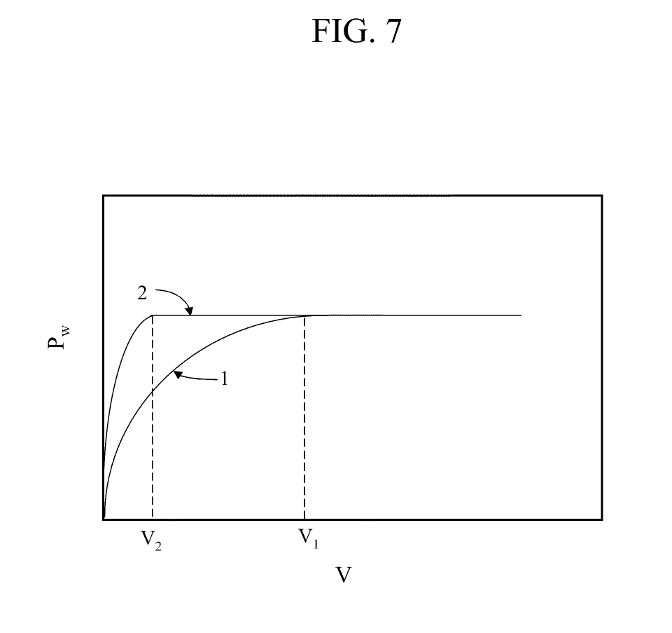

The composition of the green batch material affects the viscosity, flow and/or temperature of the batch in a mold or through an extruder, and thus affects the occurrence of fast flow or swollen webs and the final shape of the ceramic green body. For example, the viscosity and uniformity of the green batch material affects the flow of the material through an extruder, creating differential flows of the extrudate at the periphery and center of the extruder and giving rise to fast flow or swollen web formation. The flow or viscosity is affected by binder and/or liquid distribution, molecular weight of the binder, particle size and orientation, and the like. The impact of differential flow is illustrated in FIG. 7, which is a plot of wall drag pressure P_{w} as a function of the entry velocity v in the extruder barrel. It is often advantageous to operate at a velocity where the wall drag pressure P_{w} is stable or at a relatively constant value. For many cordierite batch compositions (1 in FIG. 7), the batch must be extruded at a velocity that is greater than threshold velocity v₁. The wall drag pressure P_{w} green batch compositions described herein (2 in FIG. 7) achieves a stable or relatively constant value at a lower threshold velocity v₂, which enables the green ceramic body to be extruded at lower velocities and therefore with less differential flow.

The green batch composition described herein and comprising hydrated clay, no calcined clay, and 3-10% binder provides the ceramic green body with improved wet strength and reduced internal defects. Accordingly, the ceramic green body described herein has a web structure that is 90% free of fast flow webs or deformed cell walls, as measured by counting and mapping deformed webs on a face of the ceramic green body.

A method of making a ceramic green body is also provided. In the first step of the method, a cordierite-forming green batch material is provided. The batch material is formed by mixing cordierite precursor materials and at least one binder, using those methods known in the art to obtain a plasticized green ceramic mixture or batch.

The cordierite precursor materials are selected to provide a composition of magnesium oxide (MgO), alumina (Al₂O₃), and silica (SiO₂) that will form cordierite upon firing. Cordierite precursors typically comprise talc, at least one hydrated clay, alumina, silica, and at least one binder. The at least one hydrated clay includes, but is not limited to, kaolinite, halloysite, pryophylilite, combinations or mixtures thereof, and the like. The raw and batch materials are free of calcined clays.

As described hereinabove, the cordierite-forming green batch material composition, in some embodiments, comprises: from about 12 to about 16 wt % MgO; from about 33 to about 38 wt % Al₂O₃; from about 49 to about 54 wt % SiO₂; and from about 3 wt % up to about 10 wt % of at least one binder. In one embodiment, the cordierite batch material comprises: from about 12.5 to about 15.5 wt % MgO; from about 33.5 to about 37.5 wt % Al₂O₃; and from about 49.5 to about 53.5 wt % SiO₂. Cordierite-forming and cordierite bodies also typically include impurities such as CaO, K₂O.Na₂O, Fe₂O₃, and the like.

As described hereinabove, binders that are included in the green ceramic batch material include, but are not limited to, methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof. Methylcellulose and/or methylcellulose derivatives—particularly, methylcellulose, hydroxypropyl methylcellulose, or combinations thereof—are especially suited as organic binders. The binder is part of a binder system includes the binder, a solvent for the binder, a surfactant, and a “non-solvent” component that does not act as a solvent with respect to at least the binder and other solvent components. Possible solvents, surfactants, and non-solvent components have been described hereinabove.

The ceramic green batch material is next shaped into the ceramic green body using those forming means and methods known in the art for shaping plasticized green ceramic mixtures. Such forming methods include, but are not limited to, molding, pressing, casting, extrusion, and combinations thereof. In one non-limiting example, the batch material is extruded either vertically or horizontally. Such extrusion can be achieved using a hydraulic ram extrusion press, a two stage de-airing single auger extruder, or a twin screw mixer with a die assembly attached to the discharge end of the extruder.

The ceramic green body is then fired at a selected temperature under suitable atmosphere and for a time dependent upon the composition, size and geometry of the green body so as to result in a fired ceramic body. Firing times and temperatures depend upon factors such as the composition and amount of material in the ceramic green body and the type of equipment used to fire the green body. Firing temperatures for forming cordierite typically range from about 1300° C. up to about 1450° C., with holding times at these temperatures ranging from about 1 hour to 8 hours and typical total firing times ranging between about 20 hours up to about 80 hours.

### EXAMPLES

The following examples illustrate the features and advantages of the green ceramic body and green batch material that are described herein, and are in no way intended to limit the present disclosure or appended claims thereto.

A series of six green batches of different composition were prepared and extruded to form green ceramic bodies. Compositions studied included compositions comprising a mixture of hydrated and calcined clays (Reference 1, Reference 2) and compositions comprising hydrated clays but no calcined clays (Samples 1, 2, 3, 4). For each composition, samples containing either 2.9 wt % or 5 wt % METHOCEL® methylcellulose binder were prepared.

The compositions studied are summarized in Table 1. Reference 1 is a base or reference composition presently used to form green cordierite bodies, and contains calcined clay. Reference 2 is a second reference composition for which the highest extrusion rates can be used. Reference 2 also contains calcined clays, but comprises much smaller particles (e.g., fine alumina and Artic Mist® talc) than Reference 1. Samples 2-5, having the compositions described hereinabove, comprise hydrated clays and do not contain any calcined clays. The composition of Sample 1 excluded calcined clay and had greater amounts of fine alumina and silica than Reference 1. In Sample 2, ARTIC MIST® talc, which has a platy morphology and smaller particle size than the talc that is normally used as a cordierite precursor, comprised a portion in the batch. Neutral, super-fine ground hydrated kaolin was used as the hydrated clay in Sample 3. Sample 4 had a composition that was similar to that of Reference 1, with the exception that calcined clay was excluded and all of the clay in the batch material was hydrated clay. Green honeycomb shapes were extruded from these compositions using a 40 mm twin screw extruder. The materials were extruded with 400/4 (400 cells per inch, 0.004 inch cell size) dies having a diameter of 2 and 5.66 inches, respectively.

TABLE 1
Batch compositions, expressed in wt %.

| | Reference 1 | Sample 1 | Sample 2 | Sample 3 | Sample 4 | Reference 2 |
|---|---|---|---|---|---|---|
| Talc | 40.38 | 41.8 | 20.9 | 41.8 | 42.9 | 0 |
| Calcined | 19.52 | 0 | 0 | 0 | 0 | 24.73 |
| clay | | | | | | |
| (kaolin) | | | | | | |
| Hydrated | 15.28 | 15.2 | 15.2 | 0 | 31.9 | 16.55 |
| clay | | | | | | |
| (kaolin) | | | | | | |
| Calcined | 14.04 | 14 | 14 | 14 | 14 | 0 |
| alumina | | | | | | |
| Fine | 4.68 | 13.2 | 13.2 | 13.2 | 4.7 | 5.73 |
| alumina | | | | | | |
| Silica | 6.1 | 15.8 | 15.8 | 15.8 | 6.5 | 2 |
| (Imsil) | | | | | | |
| Talc (Artic | 0 | 0 | 20.9 | 0 | 0 | 39.95 |
| Mist ®)¹ | | | | | | |
| Hydrated | 0 | 0 | 0 | 0 | 0 | 11.05 |
| alumina | | | | | | |
| (Boehmite) | | | | | | |
| Hydrated | 0 | 0 | 0 | 15.2 | 0 | 0 |
| clay² | | | | | | |

¹High purity, platy talc having lower particle size.
²Neutral, superfine ground kaolin.

Extruded ribbons of the above composition are visually compared in FIGS. 1-5. The ribbons are grouped in FIGS. 1-5 according to extrusion rate for a given formulation. All ribbons were extruded thru a 5 mil (0.005 inch) minislit opening, at 100 kJ mixing energy and a die temperature of 37° C.

FIG. 1 shows ribbons extruded at different rates for: a) Reference 1 material, with 2.9 wt % binder added; b) Reference 2 material with 5 wt % binder added; and c) Reference 1 material with 5 wt % binder added. The ribbons extruded from the Reference 1 composition (FIGS. 1a and 1c) exhibited flow defects—in particular, edge tearing—whereas the Reference 2 composition produced extruded ribbons with little or no edge tearing. The greater binder concentration (FIG. 1c) has a small effect on the generation of edge tearing in Reference 1, whereas the smaller particles in Reference 2 appeared to reduce the occurrence of such flow defects.

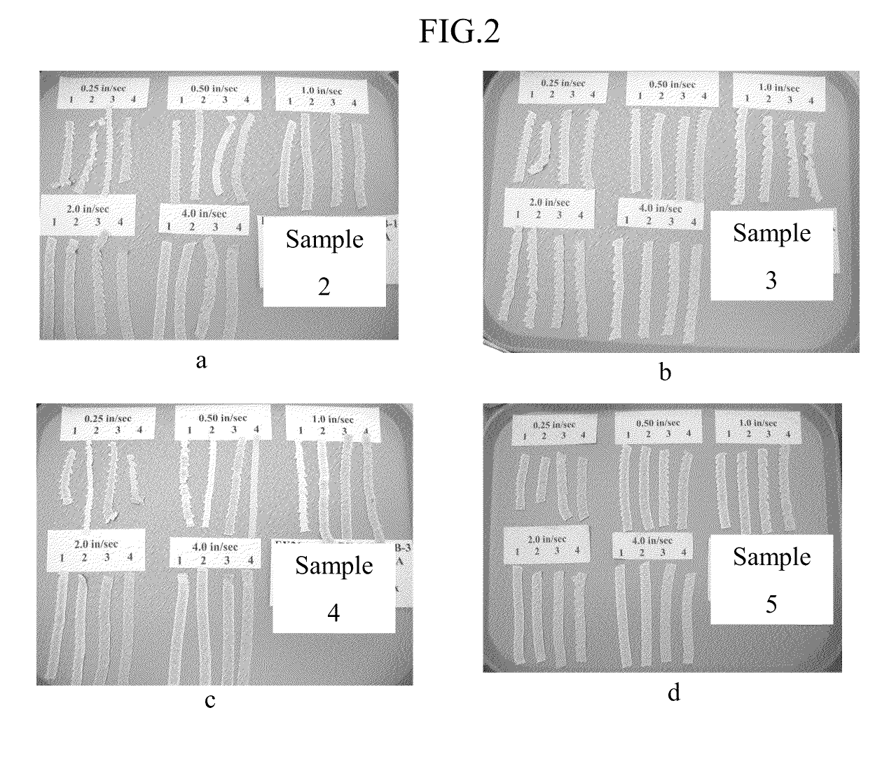

FIG. 2 shows ribbons extruded at different rates for: a) Sample 1 material with 2.9 wt % binder was added; b) Sample 2 material with 2.9 wt % binder added; c) Sample 3 material with 2.9 wt % binder added; and d) Sample 4 material with 2.9 wt % binder added. The ribbons extruded using this binder concentration showed improvement over those obtained for the Reference 1 material, especially at higher extrusion velocities.

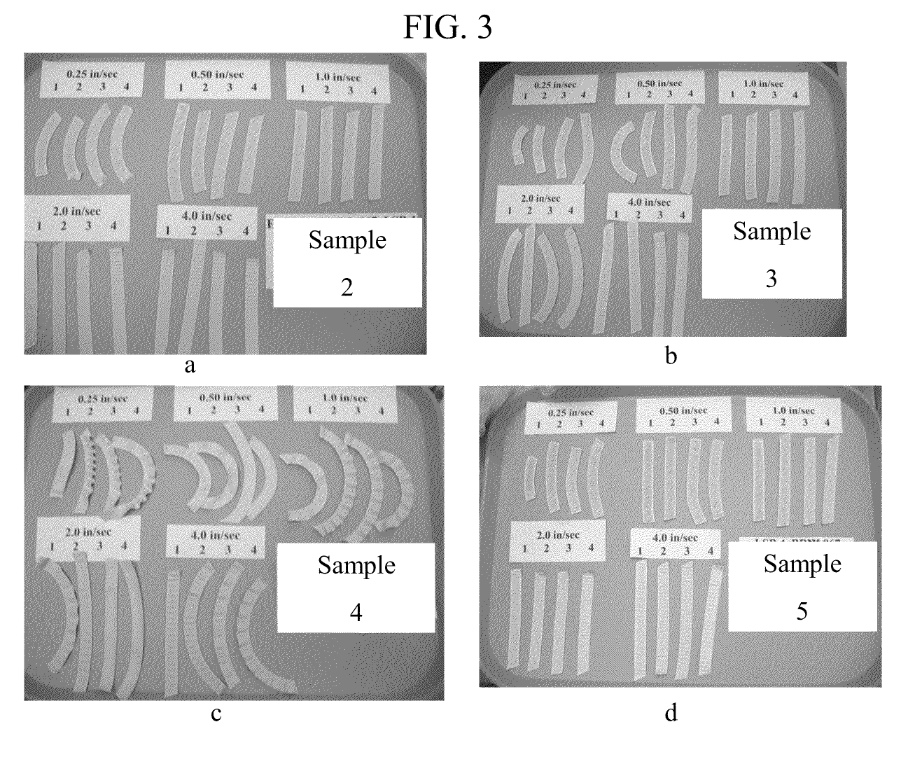

FIG. 3 shows ribbons extruded at different rates for: a) Sample 1 material with 5 wt % binder was added; b) Sample 2 material with 5 wt % binder added; c) Sample 3 material with 5 wt % binder added; and d) Sample 4 material with 5 wt % binder added. All ribbons shown in FIG. 3 are free of the edge defects seen in FIGS. 1a-c and FIGS. 2a-d. As seen in FIGS. 1a and 1c, edge defects are not removed by the addition of more binder alone. Instead, the combination of increased binder concentration and removal of calcined clay from the green ceramic batch are needed to eliminate such flow defects.

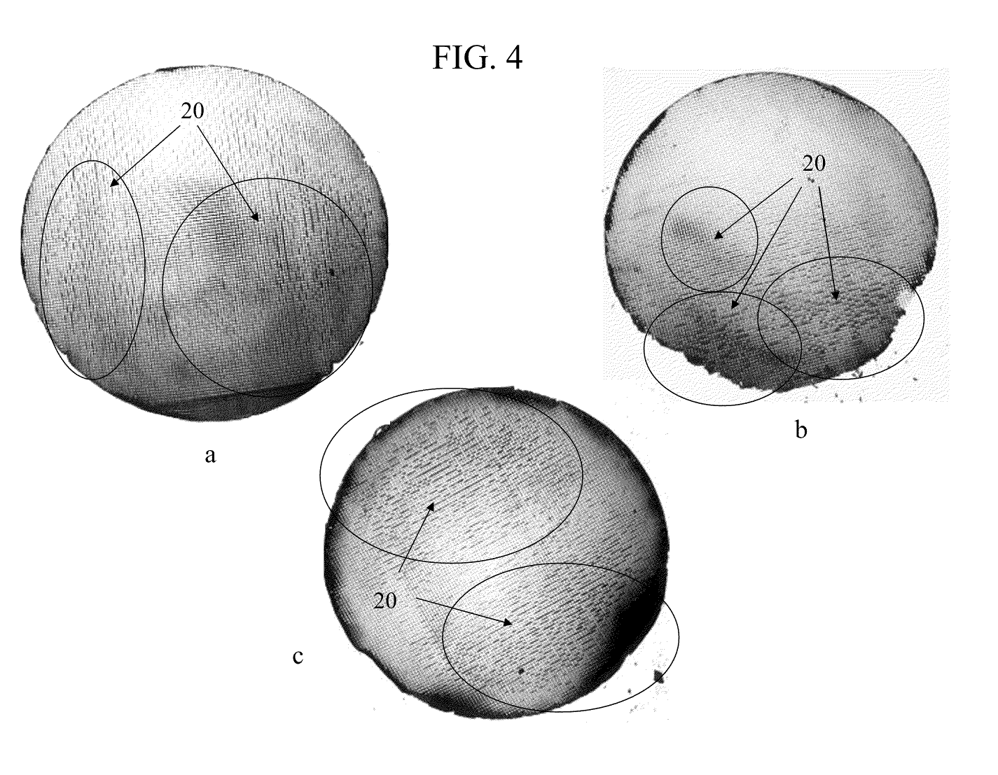

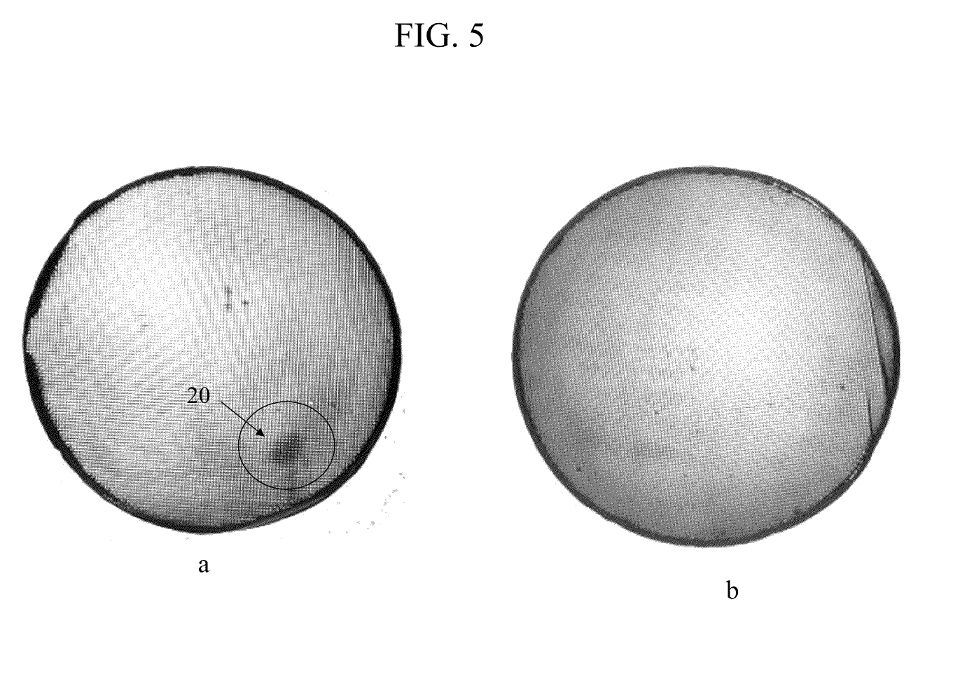

One inch thick cross-sections were cut from the extruded shapes after drying and inspected on a light box for the presence of internal defects in the web structure. Internal defects (fast flow webs) in extruded 5.66 inch diameter honeycomb web structures are shown in FIGS. 4a-c and FIGS. 5a-b. These internal defects appear as dark zones or areas 20 in FIGS. 4a-c and 5a-b. In FIGS. 4a-c, the extruded web structure obtained with the Reference 1 materials containing 2.9 wt % binder (FIG. 4a) is compared to web structures obtained using Reference 1 with (FIG. 4b) and Reference 2 materials (FIG. 4c), each containing 5 wt % binder. All three structures shown in FIGS. 4a-c exhibit fast flow webs 20. Extruded honeycomb web structures of Samples 1 and 2 materials, each containing 5 wt % binder, hydrated clays, and no calcined clays, are shown in FIGS. 5a and 5b. Fast flow webs 20 are visible in only a small region of Sample 1 (FIG. 5a), and no fast flow webs are visible in Sample 2 (FIG. 5b).

As previously described herein, the number of fast flow webs or deformed cell walls is typically measured by counting and mapping deformed webs on a face of the ceramic green body. The number of defects and percentage of defects in the extruded honeycomb web structures shown in FIGS. 4a-c and FIGS. 5a-b are listed in Table 2. The defect counts and percentage of defects were determined by the number of possible locations in the x axis direction of each part. The analysis was performed by making a grid, overlaying the grid on the part, and counting the defects in each grid. As seen in Table 2, the extruded ceramic green bodies comprising hydrated clays and no calcined clays had significantly fewer defects/fast flow webs than the green bodies formed from the reference materials.

TABLE 2
Defect counts and percentage of defects for extruded honeycomb
web structures shown in FIGS. 4a-c and FIGS. 5a-b.

| | Refer- | Refer- | Refer- | | |
|---|---|---|---|---|---|
| | ence 1 | ence 1 | ence 2 | Sample 1 | Sample 2 |
| | 2.9% | 5% | 5% | 5% | 5% |
| | binder | binder | binder | binder | binder |
| | (FIG. 4a) | (FIG. 4b) | (FIG. 4c) | (FIG. 5a) | (FIG. 5b) |
| Total | 1044 | 947 | 1423 | 42 | 3 |
| defects | | | | | |
| % X | 23.99 | 21.76 | 32.70 | 0.97 | 0.07 |
| possible | | | | | |
| locations | | | | | |

Yield and wall shear stresses generated during extrusion of the green ceramic body can be analyzed using a modified Benbow-Bridgewater equation (J. Benbow and J. Bridgewater, “Paste Flow and Extrusion,” (Clarendon Press, Oxford, 1993)) in which the total pressure is given by the sum of the entry pressure and the wall drag pressure P_{w}. The corresponding entry pressure and wall drag parameters are extracted from the equations describing the batch flow through a capillary tube.

Wall drag parameters include yield stress τ_{y}, entry pressure consistency index n, bulk consistency index k, wall drag coefficient β, and wall drag power law index m for the wall drag pressure P_{w}, wherein P_{w}=4(L/D)βv^{m}, where L and D are tube geometrical factors (length and diameter, respectively), and v is the entry velocity in the extruder barrel, expressed in inches per second (in/sec). Table 3 lists wall drag coefficient (β) and wall drag power law index (m) values obtained for References 1 and 2 and Samples 1-4, which are described hereinabove. The wall drag coefficients obtained for all samples were greater than those of the references, with Samples 1, 2, and 4 exhibiting significantly higher wall drag coefficients than those measured for the references. The larger wall drag coefficients of Samples 1-4 enable these compositions to be extruded with greater wall drag and/or than the reference materials and results in more even flow of the green batch material through the extruder. The wall drag power law index (m) values for Samples 1, 2, and 4 were significantly less than those of references 1 and 2. Sample 3 differs from Samples 1, 2, and 4 in that the hydrated clay (kaolin) used in sample 3 was more finely ground than those hydrated clays used in the other samples studied.

TABLE 3
Wall drag coefficient and wall drag power law index values
obtained for the references and samples listed in Table 1.

| | Reference 1 | Sample 1 | Sample 2 | Sample 3 | Sample 4 | Reference 2 |
|---|---|---|---|---|---|---|
| | water, | water, | 21% water, | 17% water, | 19% water, | 30% water, |
| | binder | binder | 5% binder | 5% binder | 5% binder | 5% binder |
| wt % | 23 | 19 | 21 | 17 | 19 | 30 |
| water | | | | | | |
| wt % | 2.9 | 5 | 5 | 5 | 5 | 5 |
| binder | | | | | | |
| Wall | 10.3 | 15.0 | 19.85 | 10.85 | 19.5 | 18.5 |
| drag (β) | | | | | | |
| Wall | 0.7 | 0.43 | 0.31 | 0.92 | 0.4 | 0.51 |
| drag (m) | | | | | | |

Mixing energy for all samples was 50 kJ.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A ceramic green body, the ceramic green body comprising: cordierite precursor materials, the cordierite precursor materials comprising talc, at least one hydrated clay, alumina, and silica; and at least one binder, wherein the ceramic green body is free of calcined clay.

2. The ceramic green body of claim 1, wherein the binder comprises from 3% to 10% of the ceramic green body by weight.

3. The ceramic green body of claim 1, wherein the binder comprises at least one of methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and combinations thereof.

4. The ceramic green body of claim 1, wherein the hydrated clay is at least one of kaolinite, halloysite, pryophylilite, and combinations thereof.

5. The ceramic green body of claim 1, wherein the ceramic green body has a honeycomb structure.

6. The ceramic green body of claim 5, wherein the honeycomb structure has a web structure that includes a plurality of cell walls, wherein each of the cell walls has a thickness of less than 0.005 inch.

7. The ceramic green body of claim 6, wherein 90% of the web structure is free of fast flow webs.

8. A green ceramic composition, the composition comprising cordierite precursor materials, the cordierite precursor materials comprising at least one hydrated clay, wherein the cordierite precursor materials are free of calcined clays, and at least one binder.

9. The green ceramic composition of claim 8, wherein the binder comprises from 3 wt % up to 10 wt % of the composition.

10. The green ceramic composition of claim 8, wherein the binder comprises at least one of methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and combinations thereof.

11. The green ceramic composition of claim 8, wherein the cordierite precursor materials further comprise alumina, talc, and silica.

12. The green ceramic composition of claim 8, wherein the at least one hydrated clay comprises at least one of kaolinite, halloysite, pryophylilite, and combinations thereof.

13. A method of making a green ceramic body, the method comprising the steps of:
a. providing a green ceramic batch material comprising cordierite precursor materials, the cordierite precursor materials comprising at least one hydrated clay, talc, alumina, silica, and at least one binder, wherein the batch material is free of calcined clay, and wherein the binder comprises from 3% to 10% of the batch material by weight; and
b. forming the green ceramic batch material into a green ceramic body.

14. The method of claim 13, wherein the step of forming the green ceramic batch material into a green ceramic body comprises extruding the green ceramic batch material to form the green ceramic body.

15. The method of claim 14, wherein the green ceramic body has a honeycomb structure.

16. The method of claim 15, wherein the honeycomb structure has cell walls, the cell walls having a thickness of less than 0.005 inch.

17. The method of claim 15, wherein the honeycomb structure comprises a web structure, wherein 90% of the web structure is free of fast flow webs.

18. The method of claim 13, further comprising the steps of
a. calcining the ceramic green body; and
b. firing the calcined ceramic green body to form a ceramic body.

19. The method of claim 13, wherein the at least one hydrated clay comprises at least one of kaolinite, halloysite, pryophylilite, and combinations thereof.

20. The method of claim 13, wherein the at least one binder comprises at least one of methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and combinations thereof.
